(19) United States
(12) Patent Application Publication
(10) Pub. No.: US 2013/0290414 A1
(43) Pub. Date: Oct. 31, 2013

(54) AUTOMATICALLY CREATING GROUPS OF USERS IN A SOCIAL NETWORKING SYSTEM

(71) Applicants: Zachary Ethan Carpen Rait, Palo Alto, CA (US); Blake A. Ross, Palo Alto, CA (US); Benjamin E. Hiller, Palo Alto, CA (US)

(72) Inventors: Zachary Ethan Carpen Rait, Palo Alto, CA (US); Blake A. Ross, Palo Alto, CA (US); Benjamin E. Hiller, Palo Alto, CA (US)

(21) Appl. No.: 13/455,506

(22) Filed: Apr. 25, 2012

(51) Int. Cl. G06F 15/16

(52) U.S. Cl. 709/204

(57) ABSTRACT

A social networking system facilitates a user's creation of a group of other users from among the user's connections in the user's social network. The created groups may be used, for example, to publish information to certain user-defined groups or to define privacy settings or other access rights to the user's content according to such user-defined groups. When a user adds connections to a group, the social networking system determines a characteristic associated with the group and identifies whether the characteristic is specified in user profiles of the added connections. If the user profiles lack the characteristic, the social networking system suggests to the connections to update their user profiles with the characteristic.

### BACKGROUND

The present disclosure relates generally to social networking services, and more particularly to adding information to user profiles based on the addition of users to groups of users in the social network.

Users of a social networking system may form connections, associations, or other relationships with other users based on real-life interactions, online interactions, or a mixture of both. For example, users may be from the same geographic location, may travel in the same circle of friends, or may have attended the same college or university. Content posted by a user may be made available to the user's connections via one or more of various communication channels in the social networking system, such as a newsfeed or stream. To prioritize the content available in the newsfeed or stream, a user may create a list or group of connections (also referred to as a “friend list”).

Social networking systems often make use of user-defined groups of connections. For example, a user may wish to publish information to certain user-defined groups of the user's connections in the social networking system, or the user may wish to define privacy settings or other access rights to the user's content according to such user-defined groups. As a user becomes connected with more users in the social networking system over time, mechanisms that allow a user to create groups of the user's connections become highly labor-intensive and often lead to incomplete or smaller lists because of the inherent difficulty in grouping a user's connections. However, conventional social networking systems lack a suggestion mechanism that provides suggested characteristics to users to add to their user profiles in the social network based upon the groups they belong to in the social network.

### SUMMARY

To enhance the user experience of a social networking system, the embodiments disclosed herein automatically suggest characteristics that may be used to update user profiles in the social networking system. Generally, groups of users connected to a social networking system user (e.g., a friend list) are associated with a common characteristic such as an interest, geographic location, place of education, etc. For example, each user in a group of users has user profile information including the same geographic location or the same place of education. A social networking system user has one or more connections, which are other social networking system users to whom the user is connected. The user's connections may be organized into one or more groups of connections, where all connections in a group of connections have a particular characteristic, also identified as the “common characteristic” of the group of connections. In one embodiment, when a user adds an additional user to a group of connections, the social networking service determines whether the common characteristic of the group of connections is included in the user profile of the additional user.

The social networking system may automatically update the additional user's profile with the common characteristic of the group of connections if the additional user's profile is not associated with the common characteristic. Thus, the social networking system may infer information about users of the social network based on the group of connections to which they are added and use the information to update user profiles of the users.

Based on the inference, the social networking system may perform other actions rather than automatically updating the connection's user profile. In one embodiment, the social networking system may request from the additional user or from the other connections in the group an affirmation that the additional user is associated with the common characteristic of the group. The social networking system may add the common characteristic to the user profile of the additional user if the additional user or the other connections in the group confirms that the additional user has the common characteristic. Alternatively, the social networking system may selectively associate the common characteristic with the additional user based on a likelihood that the additional user has the common characteristic determined from analyzing the additional user's interactions with the social networking system or relationship to other social networking system users. In additional embodiments, the social networking system applies one or more rules to determine whether to include the common characteristic with the user profile of the additional user.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates a high-level conceptual diagram showing connections of a user within various groups, or subsets, in a social networking system, in accordance with one embodiment.

FIG. 2 illustrates a high-level block diagram of a social networking system for suggesting characteristics to users to update their user profiles in the social networking system, in accordance with one embodiment.

FIG. 3 illustrates an interaction diagram of a method for creating a new connection grouping, in accordance with one embodiment.

FIG. 4 illustrates an interaction diagram of a method for updating profile information according with one embodiment.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of a Social Networking System

A social networking system offers its users the ability to communicate and interact with other users of the social networking system. As used herein, a “user” may be an individual or entity (such as a business or a third party application). Also, as used herein, a “connection” identifies a user of the social networking system to which another user may form, or has formed, an association or other relationship. Users join the social networking system and then connect with other users, individuals, and entities to which they desire to be connected. A user may explicitly add a connection, for example, the user selects a particular other user to be a friend of the user. Alternatively, a connection between the user and another user may be automatically created by the social networking system based on common characteristics of the users (e.g., users who are alumni of the same educational institution). Connections in social networking systems may be in both directions or may be in just one direction. For example, if Bob and Joe are both users and connect with each another, Bob and Joe are each connections of the other. If, on the other hand, if Bob wishes to connect to Sam to view Sam's posted content items, but Sam does not choose to connect to Bob, a one-way connection may be formed where Sam is Bob's connection, but Bob is not Sam's connection. Some embodiments of a social networking system allow the connection to be indirect via one or more levels of connections (e.g., friends of friends).

In addition to interactions with other users, the social networking system provides users with the ability to take actions on various types of items supported by the service. These items may include groups or networks of users to which users of the social networking system may belong, events or calendar entries in which a user might be interested, computer-based applications that a user may use via the service, transactions that allow users to buy or sell items via the service, and interactions with advertisements that a user may perform on or off the social networking system. These are just a few examples of the items upon which a user may act on a social networking system, and many others are possible. Though many of the embodiments and examples provided herein are directed to particular embodiments of a social networking system, other embodiments may include other environments involving different types of social networks, social content, and other types of websites and communication mechanisms.

User generated content enhances the user experience on the social networking system. “Content” may include any type of media content, such as status updates or other textual messages, location information, photos, videos, advertisements, and links. Content “items” are pieces of content that are represented as objects in the social networking system. In this way, users of a social networking system are encouraged to communicate with each other by “posting” content items of various types of media through various communication channels to the social networking system. Using communication channels, users of a social networking system increase their interaction with each other and engage with the social networking system on a more frequent basis. One type of communication channel is a “stream” in which a user is presented with a series of content items that are posted, uploaded, or otherwise provided to the social networking system from one or more users of the service. The stream may be updated as users add content items to the stream. Example communication channels for a social networking system are discussed further in U.S. application Ser. No. 12/253,149, filed Oct. 16, 2008, which is hereby incorporated by reference in its entirety.

However, as a user becomes connected with a large number of other users of the social networking system, the user may wish to view content generated by certain users more often than, or separately from, content generated by other users. For example, a user may have close friends, casual acquaintances, college roommates, co-workers, professional contacts, and family members as connections on the social networking system. Delineating the boundaries between these connections is desirable because the user may wish to view content from close friends and family, for example, before content from professional contacts. It may be difficult, however, for the social networking system to differentiate between professional contacts and close friends. To differentiate between connections, different groups of users to whom the user is connected may be created. Generally, a group of user connected to a social networking system user (e.g., a friend list) is associated with a common characteristic such as an interest, geographic location, place of education, etc. For example, each user in a group of users has user profile information including the same geographic location or the same place of education. Hence, groups allow a social networking system user to delineate between various other users to whom the user is connected.

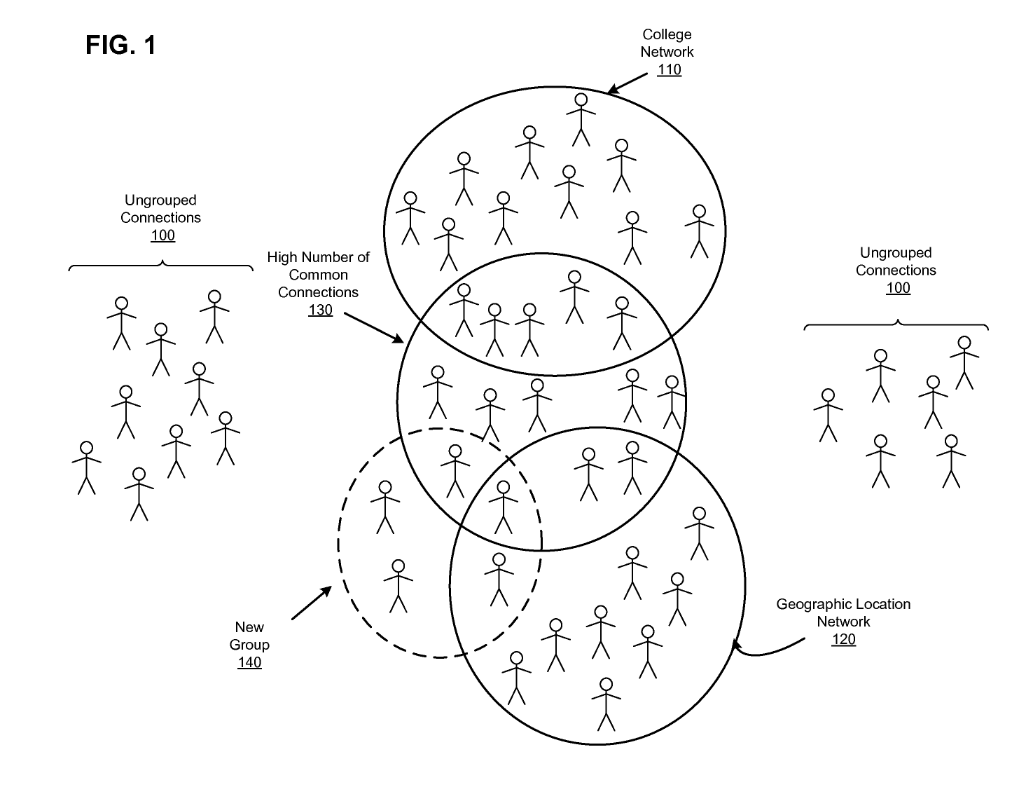

Users may connect with other users for many different reasons on a social networking system. This diversity in reasons for connecting allows a user's connections in a social network to be grouped in a variety of ways. For example, a user may group connections by the type of relationship or association shared in real life, such as co-workers, housemates, teammates, classmates, travel companions, relationships, relatives, and random connections. However, as shown in FIG. 1, a user may have many ungrouped connections 100 and a small number of connections included in groups. A user may create a group of connections that is defined by at least one characteristic common to connections included in the group. For example, a college group 110 may include connections having attended the same college and a location group 120 may include connections sharing the same geographic location 120. Another group 130 may include connections sharing a high number of common connections with each other. While each connection in a particular group has at least one common characteristic, connections included in these groups may also have many different characteristics, such as age, gender, affinities, interests, geographic location, college networks, memberships in groups, fan pages, and the like. A user may manually create a new group 140 of connections, which is a subset of the entire set of the user's connections of the user's social network.

### System Architecture

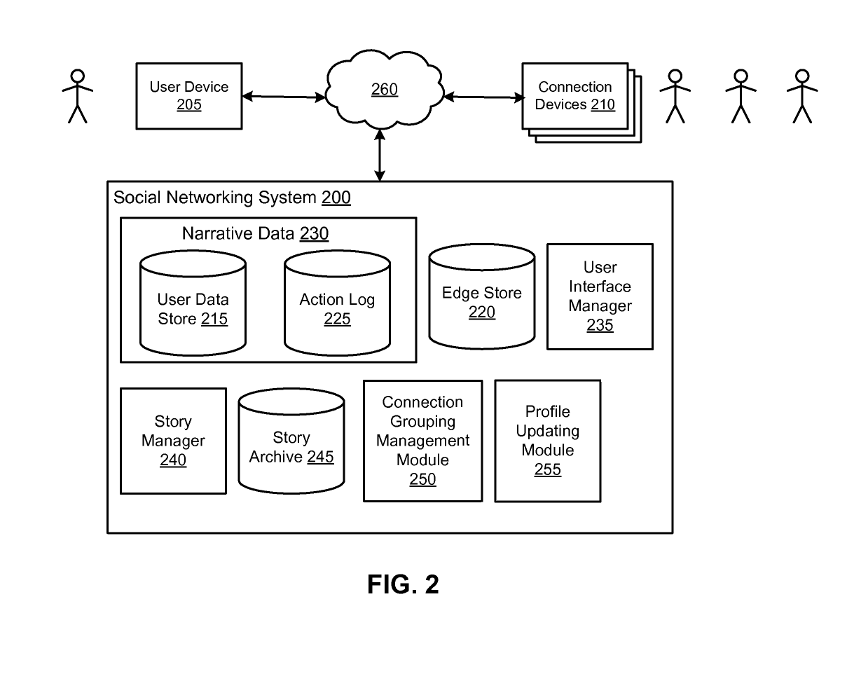

FIG. 2 illustrates a diagram of a system environment for updating a user profile of a connection in a social networking system 200 based on characteristics of a group of connections to which the connection is added (e.g., a friend list). In one embodiment, a user of the social networking system 200 may request to add the connection to a group of connections that includes connections associated with a particular characteristic. For example, the user may request to add a connection to his or her “Stanford” group of connections, which may represent connections of the user that are associated with Stanford University.

The social networking system 200 identifies the characteristic of the group of users and accesses the user profile of the connection being added to the group of connections to determine whether the characteristic is indicated in the user profile of the connection. If the user profile of the connection lacks the characteristic, the social networking system may identify the characteristic of the group of connections and suggest the connection add the characteristic to his or her user profile. In the preceding example, the social networking system may suggest the connection user add “Stanford” to the education field of the connection user's user profile. Thus, the social networking system may infer information about users of the social network based on the group of connections to which they are added and use the information to update user profiles of the users.

Users interact with the social networking system 200 using client devices, which are shown as a user device 205 and connection devices 210. The user device 205 and/or connection devices 210 are for interacting with the social networking system 200 and may be any computing device having data processing capability and data communication capability. Examples of client devices include a personal computer (PC), a desktop computer, a laptop computer, a notebook, tablet PC, a personal digital assistant (PDA), mobile telephone, smartphone, or internet tablet. These devices may include a camera sensor that allows image and video content to be captured and uploaded to the social networking system 200. These devices may also have a touch screen, gesture recognition system, mouse pad, or other technology that allows a user to interact with the social networking system 200 through a user interface provided by the social networking system 200.

The interactions between the user device 205, connection devices 210 and the social networking system 200 are typically performed via a network 260, for example, via the internet. The network 260 enables communications between the user device 205, connection devices 210, and the social networking system 200. In one embodiment, the network 260 uses standard communications technologies and/or protocols. Thus, the network 215 may include links using technologies such as Ethernet, 802.11, worldwide interoperability for microwave access (WiMAX), 3G, 4G, LTE, digital subscriber line (DSL), asynchronous transfer mode (ATM), InfiniBand, PCI Express Advanced Switching, etc.

In one embodiment, the client device 205 executes a user interface to allow a user to interact with the social networking system 200. The user interface allows the user to perform various actions or activities associated with the social networking system 200 and to view information provided by the social networking system 200. Example actions performed using the user interface include adding connections, posting messages, posting links, uploading images or videos, updating the user's profile settings, viewing stories, and the like. The information provided by the social networking system 200 that can be viewed using the user interface includes: images or videos posted by the user's connections, comments posted by the user's connections, messages sent to the user by other users, wall posts, etc.

In one embodiment, when a user “A” views the data of another user “B,” user “A” is called the “viewing user,” and the user “B” is called the “subject user.” The user interface allows a viewing user to view the data of other subject users of the social networking system 200 as well as general data related to news, sports, interests, etc. Information in the user interface may be presented to viewing users in different views. For example, the social data of subject users can be presented to viewing users by way of a “profile page,” which is an arrangement of the subject users' social networking data. The information about subject users may also be presented in the form of a news feed including stories. In one embodiment the different views consist of data and code in a web standard format presented through a browser. For example, a news feed may consist of combination of any of XML, HTML, CSS, JavaScript, plaintext and Java sent from a server to a web browser running on a client. In another embodiment a news feed may consist of data formatted for presentation through a mobile app or desktop application.

A social network story (or “story”) is an aggregation of data gathered by the social networking system 200 that is configured for display in various social networking system views (user interface views). For example, stories can be presented to viewing users in a continuously updated real-time newsfeed in a web browser, in a timeline view, or on a user's profile page. A story aggregation is simply a collection of one or more stories gathered together for display. For example, all the stories related to a particular event, such as a birthday party, may be aggregated into one story aggregation.

The social networking system 200 offers its users the ability to communicate and interact with other users of the social networking system 200. Users join the social networking system 200 and then add connections, which are other users of the social networking system 200 to whom they have a relationship or wish to have a relationship. In one embodiment, the connections of a user may be referred to as “friends” of the user. When a user joins the social networking system 200 they may create a user account. The user account enables the user to maintain a persistent and secure identity on the social networking system 200. The user account may include a user profile that stores details or characteristics about the user. Examples of details or characteristics stored by the user include name, age, sex, interests, location, education history, employment information, relationship status etc. The social networking system 200 may provide a user with stream of data to keep the user updated on the activities of the user's connections, as well as to inform the user about news and information related to the user's interests. This stream of data may include stories, which are collections of related data presented together to the user, and story aggregations, which are collections of stories presented to the user.

The social networking system 200 maintains different types of data objects, for example, user data objects, action objects, and edge objects. A user data store 215 comprises user data objects. In one embodiment, a user data object comprises user profile information related to a user of the social networking system 200. For example, a user data object may store characteristics of the user such as a user's date of birth, interests, education information, employment information, a photo of the user, a reference to a photo of the user or other suitable information about the user.

An edge store 220 stores connection objects. In one embodiment the edge store 220 stores edges that describe relationships and/or associations between users and other objects on the social networking system 240 in edge objects. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 200, such as expressing interest in a page on the social networking system, sharing a link with other users of the social networking system, and commenting on posts made by other users of the social networking system. The edge store 220 stores edge objects that include information about the edge, such as affinity scores for objects, interests, and other users as will be further described below.

The action log 225 comprises action objects. In one embodiment, an action object comprises information related to actions or activities performed by users of the social networking system 200 which have been logged in order to enhance the users' experience in the social networking system 200. Almost any activity of a user of a social networking system can be stored as an action. For example, an action can be the posting of a new comment or status update, or it can be something as simple as forming an edge to another user. The user data included in the user data store 215 and the action objects included in the action log 225 are collectively considered narrative data 230.

The social networking system 200 may maintain a social graph that tracks the relationship between the various objects, users, and events captured by the social networking system 200. In the social graph the users, the user data, and other entities, exist as nodes are connected to each other via edges. In this embodiment the edges represent actions that create a relationship between the nodes. For example, a node representing a photograph stored in the social networking system 200 may have an edge to a user that uploaded the photograph, and this edge may be an “uploaded by” action. The same photograph may have edges to several other nodes that represent the users in that photograph, and these edges may be “tagged in” actions. Similarly, a node representing a user in the social networking system 200 may have edges to each node representing posts made by that user. These edges may all be “posted by” actions. The edges in the social graph can have different types that correspond to the different types of actions taken by users of the social networking system 200.

The social networking system 200 may maintain or compute a measure of a user's “affinity” for other users (or objects) in the social networking system 200. The measure of affinity may be expressed as an affinity score, which may represent that user's closeness to another user (or object) of the social networking system 200. The affinity score of a user X for another user Y can be used to predict, for example, if user X would be interested in viewing or would be likely to view a photo of user Y. The affinity scores can be computed by the social networking system 200 through automated methods, including through predictor functions, machine-learned algorithms, or any other suitable algorithm for determining user affinities. The social networking system 200 may store an archive of historical affinity scores for a user as their affinity scores for various users and objects changes over time. Systems and methods for computing user affinities for other users of a social networking system 200, as well as for other objects in the system, are disclosed in U.S. application Ser. No. 12/978,265, filed on Dec. 23, 2010, which is hereby incorporated by reference in its entirety.

The social networking system 200 also comprises a user interface manager 235. The user interface manager 235 provides server-side functionality allowing users of the social networking system 200 to interact with the social networking system 200 using the user interface. When users request information from the social networking system 200, the user interface manager 235 dispatches the requested information to users in a format that can be displayed through a client device, such as a user device 205 or a connection device 210. For example, when a user requests a news feed from the social networking system 200, the user interface manager 235 may send stories and story aggregations to a user device 205 and/or connection devices 210 that are configured to be displayed on the devices. Depending on the type of information requested by a user, the user interface manager 235 may send stories, story aggregations, profile pages, timelines, or other data to a client device.

The story manager 240 manages the story generation process. The story manager 240 comprises story generators configured to generate stories for different purposes (i.e., different views), which are stored in the story archive 245. Story generators are configured to generate stories for a particular target view, and may restrict the selection of narrative data used in story generation based on the target view. For example, a story generator may be configured to generate stories for a photo album view, and restrict the narrative data used for story generation to narrative data including or referencing images. Stories generated to be displayed in a user interface may contain different data than stories generated to be displayed in a desktop computer interface, and they may be visually formatted in a different way in order to optimize for the differences between a desktop computer display and tactile display (e.g. larger icons for a smaller smartphone screen). The social networking system 200 may also restrict the stories that are provided to a viewing user to stories including data related to the connections of the viewing user, i.e. to stories containing data about subject users that are connected to the viewing user in the social networking system 200.

In one embodiment, the story manager 240 may generate a newsfeed, which comprises a scrollable list of the most relevant recent stories that may be of interest to a viewing user. Relevance may be determined by the story manager 240 based on affinity or other factors. The story manager 240 may generate a timeline, which is a chronological list of stories related to a particular subject user that are ordered by time period. In some embodiments, a timeline may alter the ranking of some stories depending on other factors such as social importance or likely engagement value. Stories that are configured for display in a timeline are called timeline units. A timeline may also include special “report” units, which consist of multiple timeline units that have been aggregated together. For example, a user may have several wall posts from friends during the month of November. That user's timeline may then include a report unit containing all posts from friends during that month. For newsfeeds and timelines there may be multiple story generators producing stories of different types that are displayed together. Systems and methods for generating stories for a newsfeed from data captured by a social networking system are disclosed in U.S. application Ser. No. 11/503,037, filed on Aug. 11, 2006, and U.S. application Ser. No. 11/502,757, filed on Aug. 11, 2006, which are hereby incorporated by reference in their entirety. Timelines and timeline units are discussed in more detail in utility application U.S. application Ser. No. 13/239,347, filed on Sep. 21, 2011, which is also hereby incorporated by reference in its entirety.

The connection grouping management module 250 creates groups of connections in the social networking system 200. Generally, the creation of a group of connections by a user allows the user to perform actions specific to the group of connections such as filter his or her feed based on the connections in the list, publish content to the connections on the list, or any other platform action previously described above. The connection grouping management module 250 receives one or more requests from user device 205 to create a group of connections. In one embodiment, a request includes an indication of a common characteristic associated with the group of connections. The common characteristic of the group of connections is a characteristic that is shared by each connection in the group. Examples of the common characteristic include: an interest, a geographic location, a sports team, a school, an employer or any other suitable feature.

In response to receiving a request to create a new group of connections, the connection grouping management module 250 provides the user's connections in the social networking system 200 to the user device 205. The user may select one or more of his or her connections to add to the group of connections. Generally, the user selects connections that have a characteristic that matches the characteristic associated with the connection grouping. For example, the use may add to a “Stanford” group of connections his or her friends that attended Stanford University. In one embodiment, the connection grouping management module 250 may automatically suggest connections to add to a group of connections as described in U.S. patent application Ser. No. 12/751,915 filed Mar. 31, 2010, which is hereby incorporated by reference in its entirety. In one embodiment, the connection grouping management module 250 automatically adds connections to a group of connections based on a characteristic that is common between a user and his or her connections in the social networking system 200. Once a group of connections is formed, the connection grouping management module 215 stores group data defining the group of connections in the edge store 220 and or the user data store 215. In one embodiment, the group data describes the common characteristic of the group of connections as well as the users that are part of the group of connections.

In one embodiment, the connection grouping management module 250 may save a query for connections as a connection grouping. The connection grouping management module 250 may receive a request from a user to identify his or her connections having one or more characteristics. For example, the connection grouping management module 250 may receive a request for a user's connections that live in Palo Alto, Calif. and are within 5 years of the user's age. The connection grouping management module 250 identifies the connections that match the characteristics specified in the request and may automatically create a group of connections including the identified connections. Alternatively, the connection grouping management module 250 suggests a new connection grouping to the user based on the characteristics of the user's request.

The profile updating module 255 updates user profiles based on the groups of connections in which associated users belong to in the social network. In one embodiment, the profile updating module 255 suggests to a user one or more characteristics to add to the user's user profile responsive to the user being added to a group of connections. As previously mentioned above, a group of connections includes connections that are associated with one or more common characteristics such as geographic locations, interests (e.g., animals, cars, boxing, etc.), place of education, place of work, etc. The profile updating module 255 identifies the characteristic associated with the group of connections to which the connection was added and determines whether the characteristic is included in the connection's user profile. For example, the profile updating module 255 identifies a common characteristic of a group of connections and determines whether the user profile of a user added to the group includes the characteristic. If the user profile of the connection added to the group lacks the common characteristic, the profile updating module 255 may suggest that the connection added to the group update his or her user profile to include the characteristic. In another embodiment, the profile updating module 255 may automatically update the user profile of the user added to the group with the common characteristic. Thus, the profile updating module 255 may infer information about users of the social networking system based on the groups of connections to which users are added and the profile updating module 255 may update the user's profile information accordingly.

In various embodiments, the profile updating module 255 may selectively associate the common characteristic of the group with the user profile of the user added to the group. In one embodiment, the profile updating module 255 selectively associates the common characteristic with the user profile of the user added to the group by automatically adding the common characteristic to the user's profile. Alternatively, the profile updating module 255 adds the common characteristic to the user's profile if other connections in the group have approved the common characteristic. In another embodiment, the profile updating module 255 adds the common characteristic to the added user's profile responsive to the added user confirming its addition.

In another embodiment, the profile updating module 255 automatically adds the characteristic if additional factors suggest a high likelihood that the user has the common characteristic associated with the group of connections. For example, the profile updating module 255 applies a model to information maintained by the social networking system for the user added to the group and uses the model to predict information about the added user. The profile updating module 255 may access a variety of information about the added user to infer attributes of the added user. Examples of information about the added user include: interactions between the added user and other users and/or objects in the social networking system, characteristics of other users to whom the added user is connected, locations where the added user checked-in, events that the added user attended or is planning to attend or any other suitable information. The model uses the information about the added user to generate a score predicting additional information about the user. If the score for the common characteristic equals or exceeds a threshold, the added user's profile is modified to include the common characteristic. For example, a model uses the added user's connections, locations where the added user has checked-in, events the added user has attended or is planning to attend to predict the added user's employer. If the common characteristic of the group to which the added user is added is an employer, and if the model has a threshold score for the employer equaling or exceeding a threshold, the employer is automatically added to the added user's profile.

In another embodiment, the profile updating module 255 may include a rules engine defining a set of rules used to add the common characteristic of a group to the user profile of a user added to the group. For example, the rules engine automatically adds the common characteristic to the user profile of a user added to the group if the added user's profile does not include profile information for a field associated with the common characteristics. For example, if the common characteristic is an employer and the added user's profile does not specify an employer, the added user's profile is modified to include the common characteristic. In some embodiments, the user added to the group may provide an alternative characteristic to add to his or her user profile rather than use the common characteristic suggested by the profile updating module 255.

### Connection Grouping Management

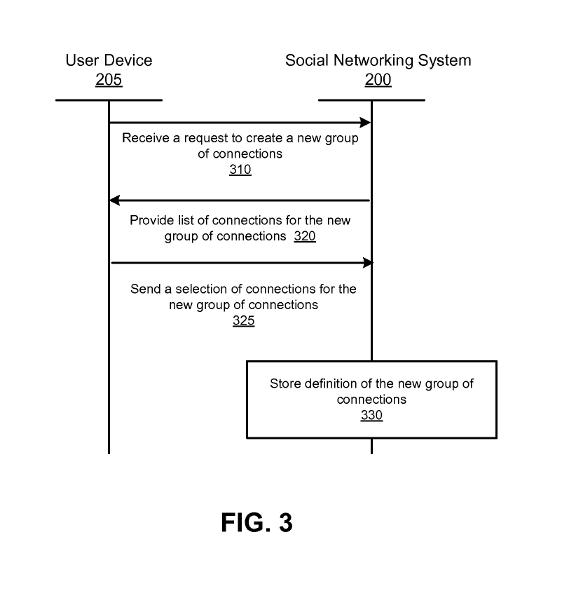

FIG. 3 illustrates an interaction diagram showing creation of a new group of connections from the user's connections in the social networking system 200. Note that in other embodiments, other steps may be performed other than those illustrated in FIG. 3.

The social networking system 200 receives 310 a request to create a new group of connections from a user device 205 associated with the user. For purposes of illustration, FIG. 3 shows the request to create the new group of connections received from a user device 205; however, in other embodiments, the social networking system 200 may automatically generate the request itself, allowing the social networking system 200 to automatically group connections for a user.

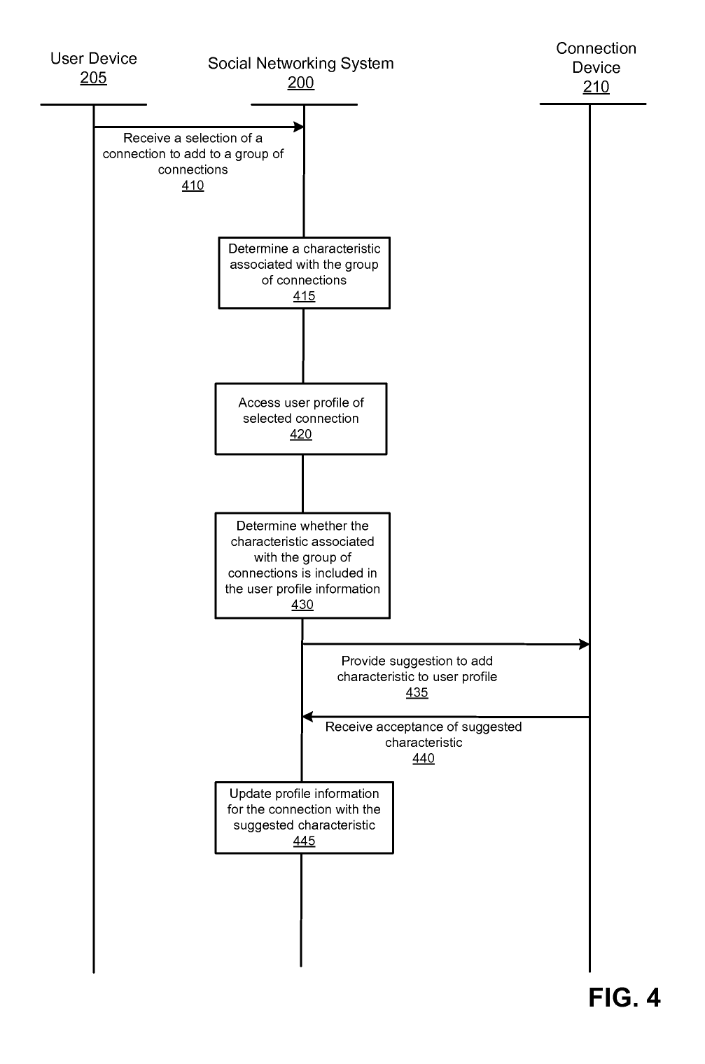

The social networking system 200 responds to the request by providing 320 the user device 205 a web page or another display has a user interface including a list of the user's connections. Through the user interface on the user device 205, the user selects connections from the list to include in a group of connections and provides one or more characteristics of connections included in the group of connections. The one or more characteristics are associated with the group of connections. The user device 205 sends 325 the user's selection of connections for the new connection grouping and the associated characteristic to the social networking system 200. When the user indicates that the user is done adding creating the new group of connections (e.g., by pressing a “save group” button), the definition of the new group of connections is stored 330 in the connection store 220 and/or the user data store 215. The social networking system 200 may suggest modifications to the user profile of a connection that is included in a new group of connections as further described below in conjunction with FIG. 4.

### Updating User Profiles

FIG. 4 illustrates an interaction diagram showing how a user profile is updated in the social networking system 200 according to one embodiment. Note that updating of user profiles of connections that are added to a connection grouping may be performed in conjunction with creating a new group of connections illustrated in FIG. 3 or may be performed when a connection is added to an existing group of connections.

The social networking system 200 receives 410 a selection of a connection to add to a group of connections from the user device 205 of a user. For example, the user may request to add a connection to his or her “Stanford” group, which includes connections of the user that attended Stanford University or have another affiliation with Stanford University. Hence, users included in the connection grouping have a common characteristic, such as Stanford University in the preceding example.

The social networking system 200 determines 415 the characteristic associated with the group of connections. In the example described above, the characteristic associated with the group of connections is “Stanford.” The social networking system 200 accesses 420 a user profile of the selected connection. For example, the social networking system 200 retrieves the user profile for the selected connection from a user data store 215. The social networking system 200 determines 430 whether the characteristic associated with the group of connections is included in the connection's user profile information. If user profile information of the connection lacks the characteristic, the social networking system 200 provides 435 a suggestion to a connection device 210 of the connection that identifies the characteristic that is recommended to be added to the connection's user profile. In the example from above, the social networking system 200 may suggest for the connection to add the characteristic “Stanford” to the education field of the connection's user profile if the user profile lacks an indication of the “Stanford” characteristic. The connection then determines whether to add the suggested characteristic to his or her user profile. In other embodiments, the social networking system 220 selectively associates the suggested characteristic with the connection's user profile, as described above in conjunction with FIG. 2.

The social networking system 200 may receive 440 an acceptance of the suggested characteristic from the connection device 250. The social networking system 200 updates 445 the profile information for the connection with the suggested characteristic. In the example described above, the characteristic “Stanford” may be added to the education field of the user profile for the connection.

### Summary

The foregoing description of the embodiments herein has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

The embodiments described herein may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments herein is intended to be illustrative, but not limiting, of the scope of the invention, which is set forth in the following claims.

What is claimed is:

1. A computer-implemented method comprising:
storing a user profile for a user of a social networking system, the user having one or more connections to one or more other users of the social networking system;
creating a group of other users of the social networking system who are connected to the user and are each associated with a common characteristic;
storing group data identifying the common characteristic and one or more connections included in the group of connections;
receiving from the user a request to add an additional user of the social networking system to whom the user is connected in the group of connections;
accessing a user profile for the additional user;
determining whether the user profile for the additional user includes the common characteristic associated with the group of connections; and
if the user profile for the additional user is not associated with the common characteristic, updating the user profile for the additional user to include the common characteristic.

2. The method of claim 1, further comprising:
transmitting a notification to the additional user suggesting that the additional user update the user profile with the common characteristic;
receiving an acceptance of the suggestion to update the user profile with the common characteristic; and
updating the user profile for the additional user with the common characteristic associated with the group of connections.

3. The method of claim 1, wherein updating the user profile comprises:
automatically adding the common characteristic to the user profile of the additional user.

4. The method of claim 1, wherein the characteristic describes a location associated with the user profile.

5. The method of claim 4, wherein the location consists of a location selected from a group consisting of a location where the additional user lives, a location where the additional user works, a location associated with frequent activity in the social networking system, and a location where the additional user was raised.

6. The method of claim 1, wherein the characteristic describes at least one of a school attended by the additional user, a genre of music, a genre of movies, a place of work, a genre of sports, or a sports team.

7. A computer-implemented method comprising:
storing a user profile for a user of a social networking system, the user having one or more connections to one or more other users of the social networking system;;
storing group data identifying a group of other users of the social networking system who are connected to the user and are each associated with a common characteristic, identifying the common characteristic and identifying one or more connections included in the group of connections;
receiving from the user a request to add an additional user of the social networking system to whom the user is connected in the group of connections;
accessing user profile information for the additional user;
determining whether the user profile information for the additional user connection includes the common characteristic; and
automatically sending a recommendation to the additional user identifying the common characteristic and suggesting to update the user profile information for the additional user to include the characteristic responsive to the profile information for the additional user lacking the common characteristic.

8. The method of claim 7, further comprising:
receiving a request from the user to identify connections associated with the common characteristic.

9. The method of claim 7, wherein the common characteristic describes an interest of the user.

10. The method of claim 7, wherein the common characteristic describes at least one selected from a group of characteristics consisting of: an employer of the user, a school associated with the user, and a geographic location associated with the user.

11. The method of claim 7, wherein automatically sending the recommendation to the additional user comprises:
automatically adding the common characteristic to the profile information of the additional user.

12. The method of claim 7, further comprising:
receiving an acceptance of the suggestion to update the profile information from the additional user; and
updating the profile information of the additional user with the common characteristic.

13. The method of claim 7, wherein automatically sending the recommendation to the additional user comprises:
receiving an alternative characteristic specified by the additional user to include in the user profile information; and
updating the profile information of the additional user with the alternative characteristic specified by the additional user.

14. A computer-implemented method comprising:
storing a user profile for a user of a social networking system, the user having one or more connections to one or more other users of the social networking system;
creating a group of other users of the social networking system who are connected to the user and are each associated with a common characteristic;
storing group data identifying the common characteristic and one or more connections included in the group of connections;
receiving from the user a request to add an additional user of the social networking system to whom the user is connected to in the group of connections;
accessing a user profile for the additional user;
determining whether the user profile for the additional user includes the common characteristic associated with the group of connections; and
inferring that the additional user comprises the common characteristic based on the request to add the additional user to the group of connections; and
a step for selectively associating the common characteristic with the user profile for the additional user.

15. The method of claim 14, further comprising:
receiving a request from the user to identify connections associated with the common characteristic;
identifying connections associated with the common characteristic; and
adding the identified connections to the group of connections.

16. The method of claim 14, wherein the characteristic describes an interest of the user.

17. The method of claim 14, wherein the characteristic describes at least one selected from a group of characteristics consisting of: an employer of the user, a school associated with the user, and a geographic location associated with the user.

18. The method of claim 17, wherein the geographic location consists of a geographic location selected from a group consisting of a location where the additional user lives, a location where the additional user works, a location associated with frequent activity in the social networking system, and a location where the additional user was raised.
